(19) United States
(12) Patent Application Publication
(10) Pub. No.: US 2011/0110553 A1
(43) Pub. Date: May 12, 2011

(54) Headset

(75) Inventor: Ty Logan, Victoria (AU)

(73) Assignee: TY-TECHTRONICS PTY LTD, Melbourne, Victoria (AU)

(21) Appl. No.: 13/000,059

(22) PCT Filed: Nov. 18, 2008
(86) PCT No.: PCT/AU08/01713

§ 371 Date: Jan. 10, 2011

(30) Foreign Application Priority Data
Jun. 20, 2008 (AU) 2008903173

(51) Int. Cl. H04R 1/10

(52) U.S. Cl. 381/380

(57) ABSTRACT

A headset including first and second ear assemblies, each ear assembly including a rear limb, a front limb, a transducer carried on the front limb, and an earpiece extending from the front limb. The rear limb is configured to locate behind a user's ear and the front limb is configured to extend around an upper portion of the user's ear and locate the earpiece in or near an ear canal of the user. The headset further includes a flexible elongate housing configured to house one or more equipment modules, the housing configured to fit conformingly around a nape region of the user's neck when the headset is worn. Each ear assembly is connected to the housing and/or the equipment modules by an elastic strap.

### FIELD OF THE INVENTION

The present invention relates to a headset, and in particular to a waterproof headset offering a variety of functionality for communications or entertainment during exercise use.

### BACKGROUND OF THE INVENTION

As electronics technology continues to advance consumer demand is increasingly moving towards the consolidation of multiple different (and previously separate) functions into singular electronic devices.

This demand presents a number of challenges to designers and manufacturers. The first of these challenges is the selection of what different functionalities it would be useful/desirable to combine.

Once this has been decided, however, the often more difficult challenge of creating a device that achieves the incorporation of those functions must be overcome. In dealing with this challenge consideration needs to be given not only to the engineering aspects of making the various functions work and interoperate, but also the human interaction considerations of how a user will actually use the device. This interaction element is of significant importance, with any number of failed products testifying to the fact that regardless of how attractive the functions of a device are, if actually using the device/accessing those functions is too difficult the device will not be used and will be unsuccessful.

Adding a final complication to the considerations of electronic feasibility and usability is the issue of design—both from an aesthetic and ergonomic viewpoint. Consumers not only want devices that are simple to use and incorporate numerous functions, but those devices must be aesthetically appealing. Further, the aesthetic appeal of the exterior design must increasingly be functional in its own right, with many users wanting to be able to wear devices under different conditions rather than merely carry them in their hands or a bag.

The ergonomic aspect is of particular importance where devices are to be used in exercise or similar and need to be both comfortable to wear and not become dislodged or disconnected during the movement of exercise.

### SUMMARY OF THE INVENTION

In one aspect the present invention provides a headset including first and second ear assemblies, each ear assembly including a rear limb, a front limb, a transducer carried on the front limb, and an earpiece extending from the front limb, the rear limb configured to locate behind a user's ear, the front limb configured to extend around an upper portion of the user's ear and locate the earpiece in or near an ear canal of the user, the headset further including a flexible elongate housing configured to house one or more equipment modules, the housing configured to fit conformingly around a nape region of the user's neck when the headset is worn, and wherein each ear assembly is connected to the housing and/or the equipment modules by an elastic strap.

The elastic straps connecting each ear assembly to the housing and/or equipment modules may be adjustable.

The rear limb may extend downwardly and terminates in an inwardly angled portion which, in use, is arranged to abut against the user's head.

The transducer may be located in a transducer housing, the transducer housing extending normally from the upper arm.

The headset may further include first and second relatively rigid equipment modules housed towards opposite ends of the elongate housing and spaced apart from one another by a central flexible region, the central region corresponding to the centre of the nape region of the user's neck when the headset is worn.

The housing may include first and second elastically deformable cavities for receiving respectively the first and second equipment modules.

The first and second equipment modules may be interconnected by a flexible cable, the flexible cable passing through the central region.

The first equipment module may be electrically connected to the transducer of the first ear assembly by a first flexible cable, and the second equipment module may be electrically connected to the transducer of the second ear assembly by a second flexible cable.

The first and/or second equipment module may include user operable buttons, the user operable buttons operable through the material of the housing.

The first and/or second equipment module may include user operable buttons, the user operable buttons operable through openings in the material of the housing.

The headset may further include first and second attachment points for attaching a front head band which, in use, extends around a forehead of the user to aid in securement of the headset to the user's head.

The first and second attachment points may be respectively located on the first and second ear assemblies.

The first and second equipment modules may collectively house a processor, a memory, a radio receiver, and a battery.

The processor may be adapted to decode digital audio data stored on the memory and play said digital audio data to the user through the first and/or second transducers.

The radio receiver may be adapted to receive a radio signal for playing though the first and/or second transducers.

The radio receiver may be adapted to oscillate between at least two radio frequencies to receive radio signals broadcast on said at least two frequencies for playing through the first and/or second transducers.

The processor may be adapted to receive heart rate signals carrying information relating to the heart rate of the user and to provide audio feedback regarding the user's heart rate to the user through the first and/or second transducers.

In a second aspect the present invention provides a headset including first and second ear assemblies being shaped to locate first and second transducers in or near the ear canal of a user, the first and second ear assemblies connected to a resilient support carrying at least one equipment module, the first and second ear assemblies being in electrical communication with the at least one equipment module, the at least one equipment module housing a processor, a receiver, a memory, and a battery, the processor adapted to process audio data stored on the memory and play said audio data to a user through the first and/or second transducers.

The receiver may be a radio receiver adapted to receive a radio signal for playing though the first and/or second transducers.

The radio receiver may be adapted to oscillate between at least two radio frequencies to receive radio signals broadcast on said at least two frequencies for playing through the first and/or second transducers.

The processor may be adapted to receive heart rate signals carrying information relating to the heart rate of the user and to provide audio feedback regarding the user's heart rate to the user through the first and/or second transducers.

The headset may be waterproof.

It will be understood that the invention disclosed and defined in this specification extends to all alternative combinations of two or more of the individual features mentioned or evident from the text or drawings. All of these different combinations constitute various alternative aspects of the invention.

### BRIEF DESCRIPTION OF THE DRAWINGS

An embodiment of the present invention will now be described in relation to the following drawings in which:

FIG. 1 provides a rear perspective view of an assembled headset in accordance with an embodiment of the present invention;

FIG. 2 provides a front perspective view of the headset of FIG. 1;

FIG. 3A provides a side view of the internal face of a left ear assembly of the headset shown in FIG. 1;

FIG. 3B provides a side view of the internal face of a left ear assembly of the headset shown in FIG. 1 with connecting cable;

FIG. 3C provides a side view of the internal face of a left ear assembly of the headset shown in FIG. 1;

FIG. 3D provides a side view of the external face of a left ear assembly of the headset shown in FIG. 1;

FIG. 3E provides a perspective view of the internal face of a left ear assembly of the headset shown in FIG. 1;

FIG. 3F provides a perspective view of the external face of a left ear assembly of the headset shown in FIG. 1;

FIG. 3G provides a top view of a left ear assembly of the headset shown in FIG. 1;

FIG. 3H provides a bottom view of a left ear assembly of the headset shown in FIG. 1;

FIG. 3I provides a rear view of a left ear assembly of the headset shown in FIG. 1;

FIG. 3J provides a front view of a left ear assembly of the headset shown in FIG. 1;

FIG. 3K provides a side view of the internal face of a right ear assembly of the headset shown in FIG. 1;

FIG. 3L provides a side view of the external face of a right ear assembly of the headset shown in FIG. 1;

FIG. 3M provides a perspective view of the internal face of a right ear assembly of the headset shown in FIG. 1;

FIG. 3N provides a perspective view of the external face of a right ear assembly of the headset shown in FIG. 1;

FIG. 3O provides a top view of a right ear assembly of the headset shown in FIG. 1;

FIG. 3P provides a bottom view of a right ear assembly of the headset shown in FIG. 1;

FIG. 3Q provides a rear view of a right ear assembly of the headset shown in FIG. 1;

FIG. 3R provides a front view of a right ear assembly of the headset shown in FIG. 1;

FIG. 4A provides a side perspective view of the headset of FIG. 1 as worn by a user;

FIG. 4B provides a rear view of the headset of FIG. 1 as worn by a user;

FIG. 5A provides a perspective view of an earpiece for use with the headset of FIG. 1;

FIG. 5B provides a perspective view of an alternative earpiece for use with the headset of FIG. 1;

FIG. 6 provides an exploded view of the attachment of the transducer housing and earpiece to the left ear assembly of FIG. 1;

FIG. 7 provides a functional block diagram depicting the various components of the headset depicted in FIG. 1;

FIG. 8A provides an exploded view of the components of the left equipment module of the headset of FIG. 1;

FIG. 8B provides an exploded view of the components of the right equipment module of the headset of FIG. 1; and

FIG. 8C provides a partially exploded view of the components of the headset of FIG. 1.

### DETAILED DESCRIPTION OF THE EMBODIMENTS

### Headset Overview

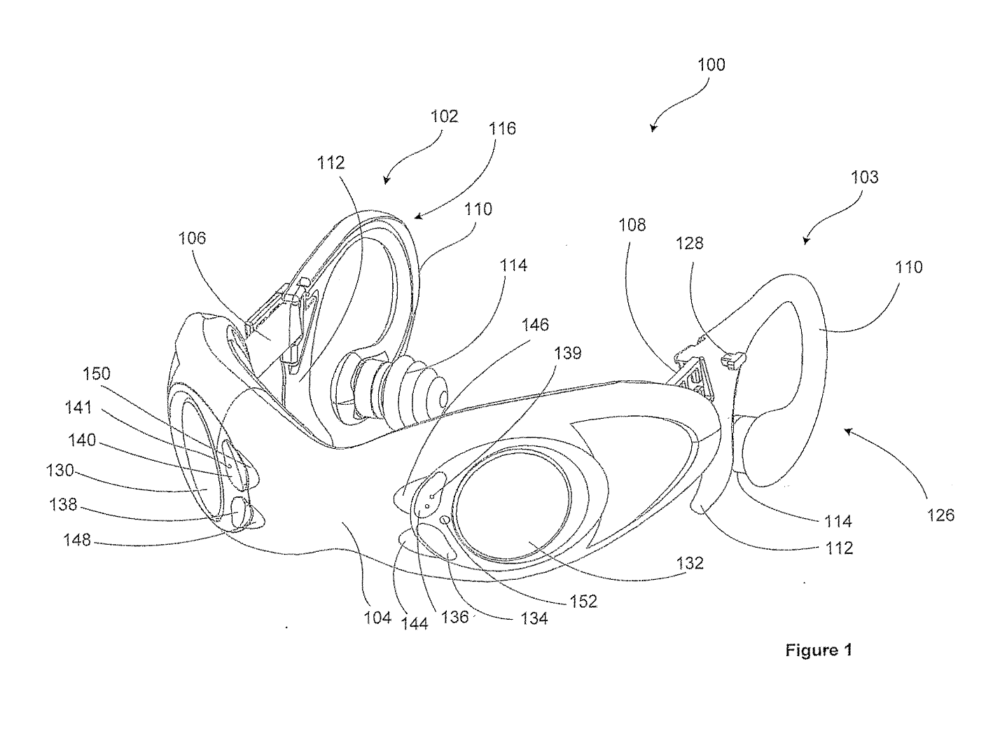

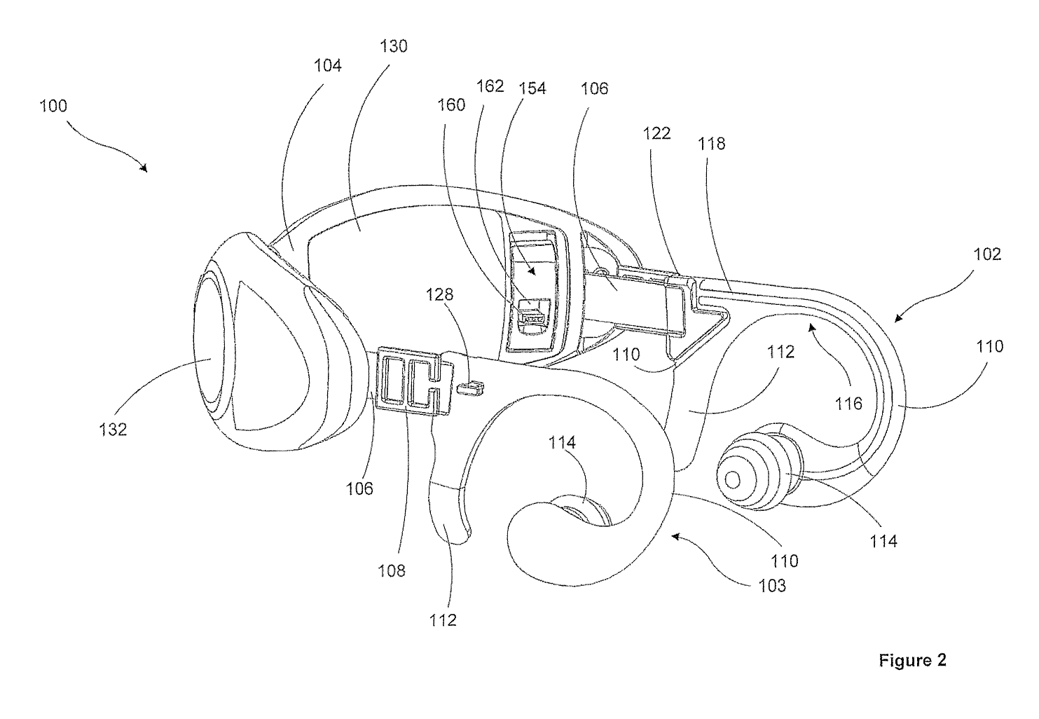

Referring first to FIGS. 1 and 2 an overview of the physical components of an embodiment of the waterproof headset 100 of the invention will be described.

FIG. 1 provides a perspective view of an assembled headset 100. The headset 100 includes a left ear assembly 102 and a right ear assembly 103 joined by a flexible elongate housing 104. The ear assemblies 102 and 103 are each attached to the housing 104 by a strap 106. The distance between the ear assemblies 102/103 and the housing 104 may be adjusted via buckles 108 through which each of the straps 106 pass.

Each of the ear assemblies 102 and 103 includes a front arm 110 and a rear arm 112. Secured to the front arm 110 of each ear assembly 102 is a transducer housing 114. The internal face 116 of each ear assembly 102/103 is formed with a channel 118 for receiving a cable 120. The channel 118 is formed with a short branch 122 and a long branch 124 which provide for management of the cable 120 when the straps 106 are shortened or lengthened via the buckles 108.

The outer surface 126 of each ear assembly 102/103 is also provided with a lug 128. The lugs 128 are shaped to allow attachment of a front head band.

The various features of the ear assemblies 102/103 will be discussed in further detail below with regard to the ergonomics of the headset 100. In this embodiment the two ear assemblies 102/103 are mirror images of each other, however it will be appreciated that if desired the ear assemblies 102/103 may differ from one another or the headset 100 may be provided with a single ear assembly only.

The housing 104 is, in this particular embodiment, provided with two waterproof equipment modules: a left equipment module 130 and a right equipment module 132. As will be discussed in further detail below, the equipment modules 130 and 132 house the various electronic components of the headset 100.

The equipment modules 130 and 132 are provided with four user buttons 134, 136, 138 and 140. For user reference, the four user buttons may be labelled or marked as a “mode” button 136, a “play/stop/power button” 135, an “up” button 140, and a “down” button” 138. To allow for tactile identification of the buttons button 138 is provided with two raised pips 139 and button 140 is provided with a single raised pip 141. The housing 104 is formed with recesses 144, 146, 148 and 150 corresponding respectively to the four user buttons 134, 136, 138 and 140 and allowing for easy manipulation of those buttons. Equipment module 132 is also provided with a transparent portion 152 which allows light from an indicator (in this case is a Light Emitting Diode (LED) type indicator) to be seen by a user.

Each of the user buttons 134, 136, 138 and 140 are provided with waterproof seals (not shown) to prevent liquid entering the equipment modules 130 and 132 in the event the headset 100 is exposed to water or submerged.

Use of the user buttons 134, 136, 138 and 140 to control the various functions offered by the headset will be described in further detail below.

Equipment module 130 also includes a hatch 154 concealing an input port 156 (in this case a USB socket) accessible from the front surface 158 of the headset 110. The hatch 154 includes a ridge 160 which can be manipulated by a user to engage or disengage a latch 162. This allows a user to selectively seal or allow access to the input port 156. The hatch 154 is provided with a rubber seal (not shown) such that when the hatch is closed by the latch the seal prevents water from contacting the input port 156 in the event of submersion of the headset 100 in water. To ensure the hatch 154 is properly closed the switch 160 is provided with a graphic such as an arrow (not shown) which is only visible when the hatch 154 is properly sealed.

### Headset Ergonomics

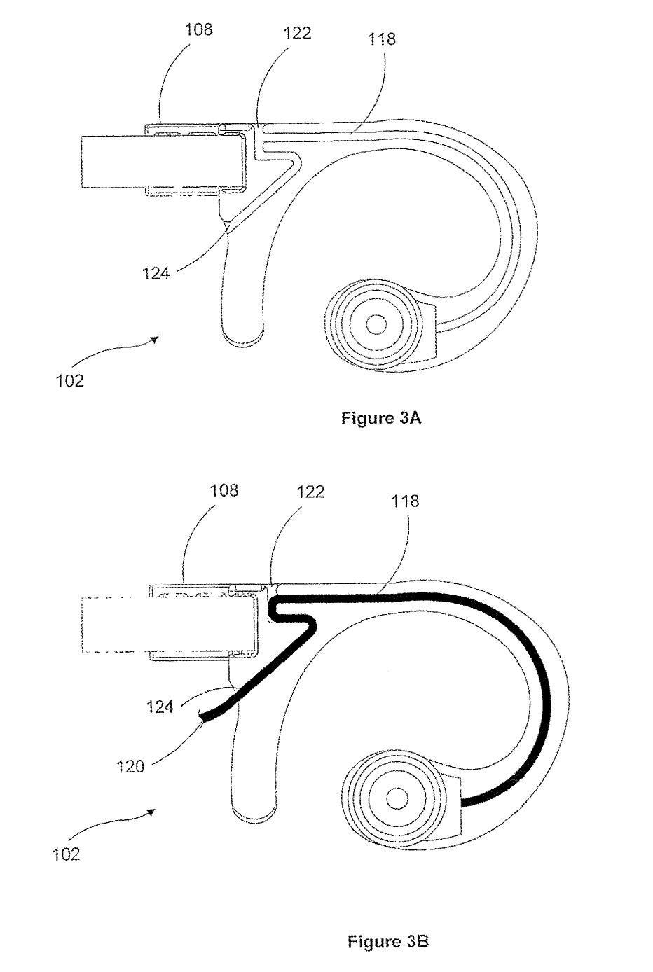

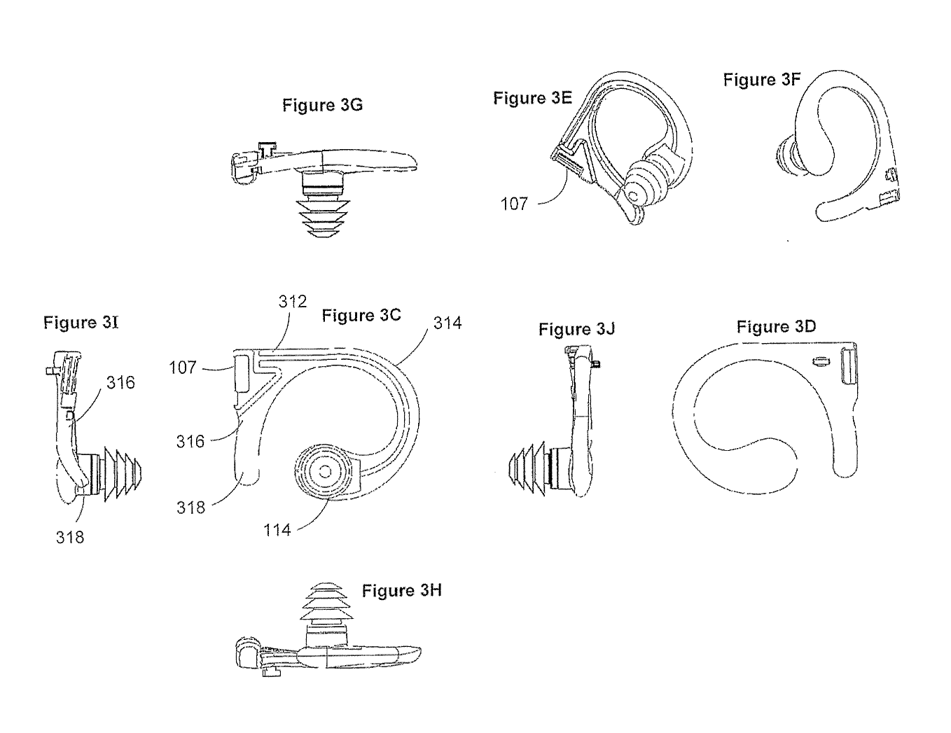

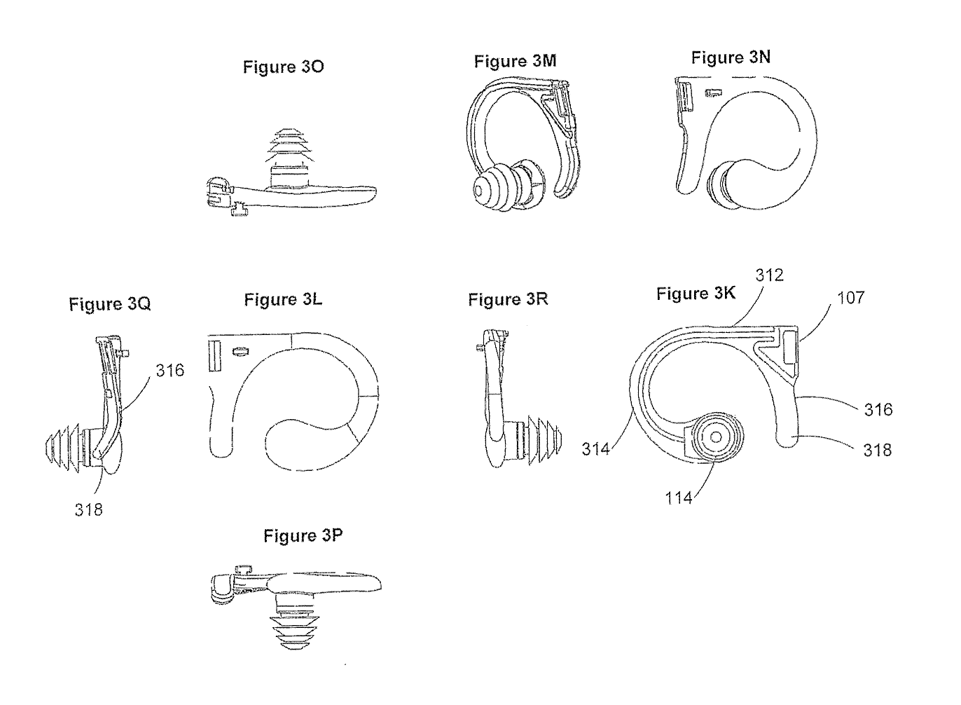

The ergonomic design of the ear assemblies 102/103 of headset 100, will now be described in detail with reference to FIGS. 3A to 3R.

Referring to FIGS. 3A and 3B, a side view of the internal face 116 of the left ear assembly 102 is provided. From this view the channel 118, with short branch 122 and long branch 124, can clearly be seen. The channel 118 is formed in the ear assembly 102 specifically to house the cable 120 which connects the respective equipment modules 130 and/or 132 to the transducer 115 located in the transducer housing 114.

As the buckle arrangement 108 allows the distance between the distance between the ear assemblies 102 and the housing 104 (and, in turn, the waterproof equipment devices 130 and 132 housed therein) to be varied, cable 120 is provided with sufficient length to cater for the greatest distance that can be provided between the ear assembly 102 and housing 104.

When the ear assembly 102 is positioned distally to the housing, therefore, there is little slack in the cable 120 which is therefore located in short branch 122 of the channel 118. Alternatively, when the ear assembly 102 is positioned proximate to the housing there is a greater amount of slack in cable 120. To manage this excess slack the cable is located in the re-entrant long branch 124 of the channel 118 which, as can be seen in FIG. 3B, accommodates a greater length of cable 120.

The right ear assembly 103 is provided with a similar channel to aid in cable management.

### Left and Right Ear Assemblies

Referring now to FIGS. 3C to 3R, the left and right ear assemblies 102 and 103 of headset 100 will now be described. FIGS. 3C to 3J provide various perspective and plan views of the left ear assembly 102 and FIGS. 3K to 3R provide various perspective and plan views of the right ear assembly 103. As will be appreciated the left and right ear assemblies 102/103 are essentially mirror images of each other and the same reference numerals have been used for corresponding components.

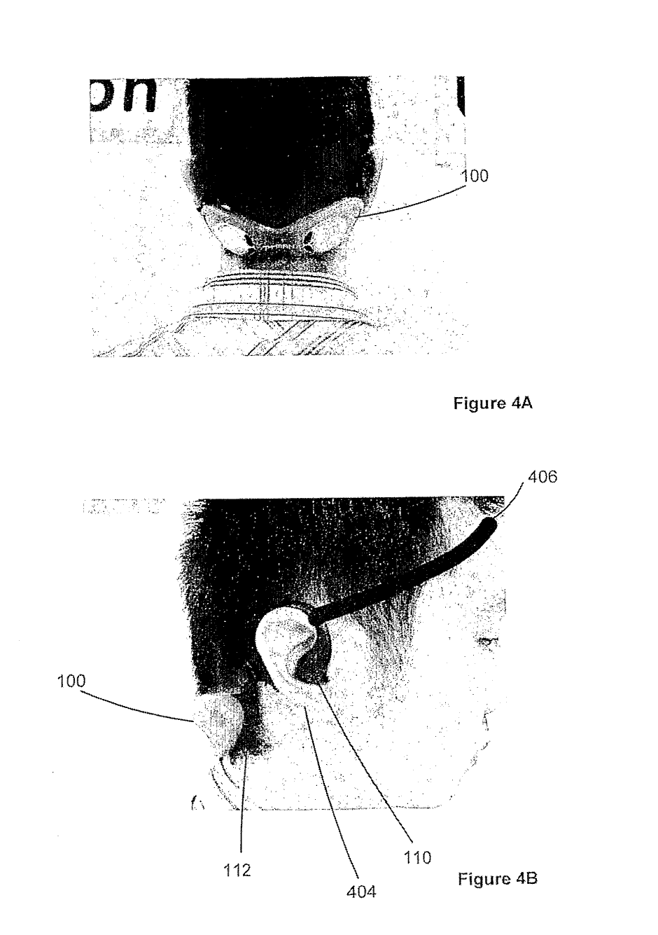

The front arm 110 of the ear assemblies 102/103 includes a substantially horizontal arm section 312 extending away from the attachment point 107 and leading into an arcuate arm section 314 which terminates in the bulbous transducer housing 114. In use (and as described in relation to FIGS. 4A to 4B), the horizontal arm section 312 rests on the top of or above a user's ear and the arcuate arm section 314 extends to position the transducer housing 114 (and hence transducer 115) in the opening to the user's ear canal.

The rear arm 112 of the ear assembly 102/103 extends downwardly from the horizontal arm section 312 of the front arm 110 and includes an outwardly angled section 316 and an inwardly angled section 318. As can be most clearly seen in FIGS. 3I and 3Q (providing rear views of the left and right ear assemblies 102/103), the outwardly angled and inwardly angled sections 316 and 318 extend out of the plane in which the arcuate section 314 of the front arm 110 lies.

When worn by a user (and as depicted in FIGS. 4A and 4B), the rear arm 112 is located behind the ear of the user and the raised profile of the outwardly angled and inwardly angled sections 316 and 318 cause the inward section 318 to apply a slight pressure against the user's head behind their ear. This pressure assists in retaining the headset 100 in position during movement of the user.

The front and rear arms 110 and 112 of the ear assemblies 102/103 are manufactured from a relatively rigid plastics material such as acrylonitrile butadiene styrene (ABS). All edges of the arms 110 and 112 are smoothed and rounded to prevent undue discomfort to a user and, as described above, the cables connecting the transducers 115 in the transducer housings 114 to the equipment modules 130 and 132 are recessed in the channel 118 to prevent the cable digging into the user's head.

The housing 104, in which the equipment modules 132 and 132 are housed, is formed of a soft and elastomeric plastics material such as a silicone rubber compound. This allows the housing 104 to be bent at the intersection of equipment modules 130 and 132 (which are connected by a cable as discussed below) which in turn allows the housing 104 to follow the contour of the upper neck or nape of a user as shown in FIGS. 4A and 4B.

The manner in which the headset 100 is worn will now be described with reference to FIGS. 4A and 4B which show side and rear perspective views of the headset in place on the head 402 of a user. When wearing the headset 100, the front arms 110 of the ear assembles are placed above the user's ears 404 such that the rear arms 112 sit behind the user's ears 404 and front arms 112 extend around the tops of the user's ears and position the earpieces 114 in or near the user's ear canals.

The buckle 108 allows the straps 106 connecting the ear assemblies 102 to the housing 104 to be shortened or lengthened to enable the user 402 to adapt the headset 100 to their particular head shape. Further, the elasticity of the straps 106 allows the ear assemblies 102 to exert a slight pull on the housing 104 (to assist with keeping the headset 100 in place) without providing significant discomfort to the user 402.

If the user's head shape is such that the headset 100 does not stay in place, or the user is undertaking exercise that is causing the headset 100 to be dislodged, the lugs 128 on the ear assemblies 102 may be used to attach a front head band 406 to the headset 100. The front head band 406 is formed of an elastic material such as a silicone rubber compound and is worn around the forehead of the user 402. The front head band 406 is provided with several apertures 408 at either end, any of which may engage with the lugs 128 of the ear assemblies 102 to alter the length of the head band 406 as desired. The elasticity of the head band 406 allows the head band 406 to exert a pull on the headset 100 thus providing a more secure fit.

To allow for further customisation of the headset 100, the ear assemblies 102 are provided with detachable earpieces. In this way earpieces of different shapes and sizes may be supplied with the headset 100 (or purchased separately) and a user can select and attach the earpiece to the transducers that are most comfortable and/or appropriate for the particular use of the headset.

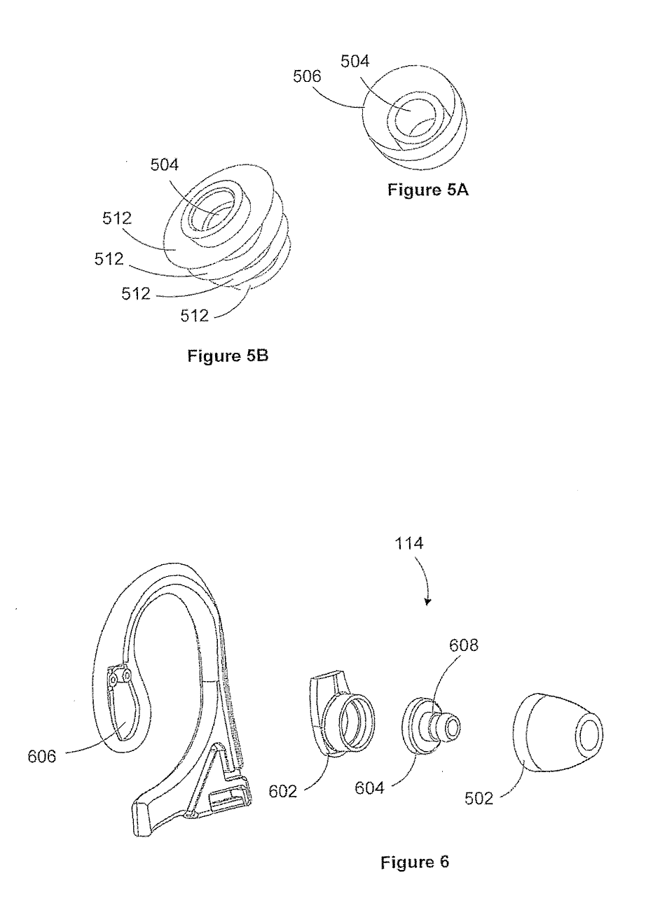

FIGS. 5A and 5B provide perspective views of two different earpieces suitable for use with the invention. The earpiece 502 shown in FIG. 5A is for normal use, and has a hollow core 504 surrounded by a dome shaped insert 506. The earpiece 510 shown in FIG. 5B is for use in water sports (such as swimming) and is also formed with a hollow core 504. Earpiece 510, however, is provided with a plurality of frusto-conical skirts 512 of progressively increased diameter spaced along the outside of the hollow core 504. When inserted in a user's ear the discs 512 help prevent the ingress of water into the user's ear.

The earpieces 504 and 506 are manufactured from a soft deformable material such as ABS which is comfortable for a user to wear and may, of course, be provided in a variety of different sizes for different sized ears.

FIG. 6 provides an exploded view of the attachment of the transducer housing 114 and earpiece 504 to the left ear assembly 102. As can be seen, the transducer housing 114 includes a moulded housing component 602 and a moulded ear piece mounting 604 of top hat section. When assembled the cable leading from the equipment module 130 or 132 follows the channel 118 into a recess 606 where it is connected with a transducer (not shown). The housing component 602 fits into the recess 606 to cover and protect the transducer, and the mounting 604 provides a cover over the top of the housing 602. The mounting 602 is roughly cylindrical in shape and is provided with an annular channel 608 over which the earpiece 502 fits.

### Equipment Modules—Block Diagram

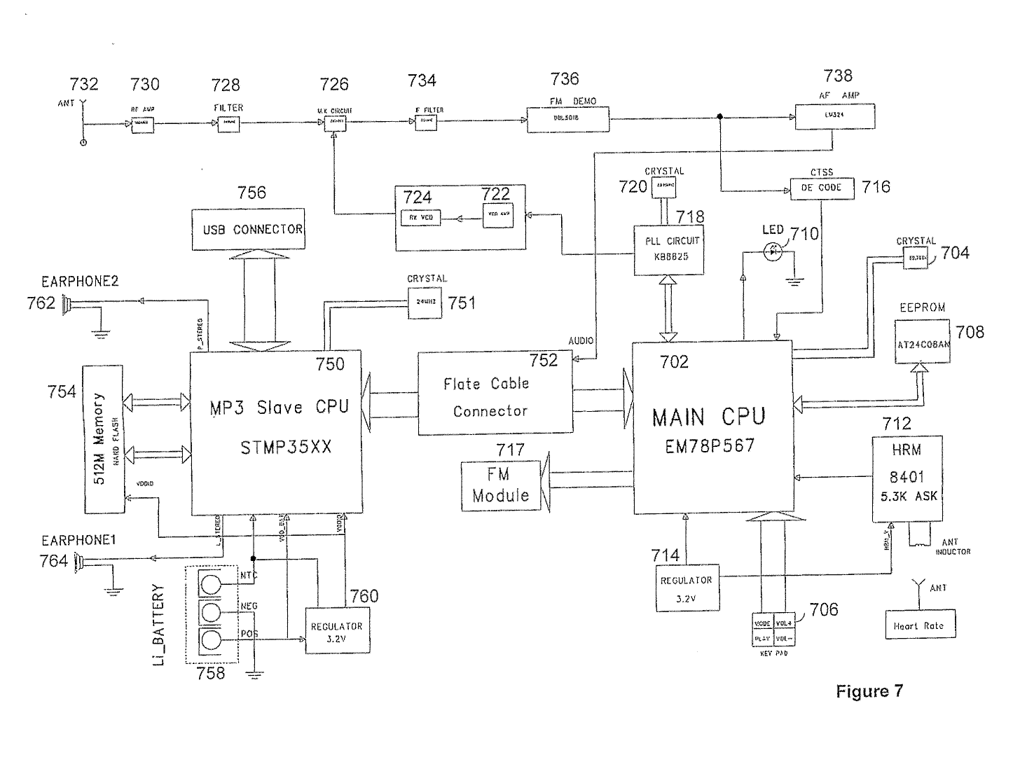

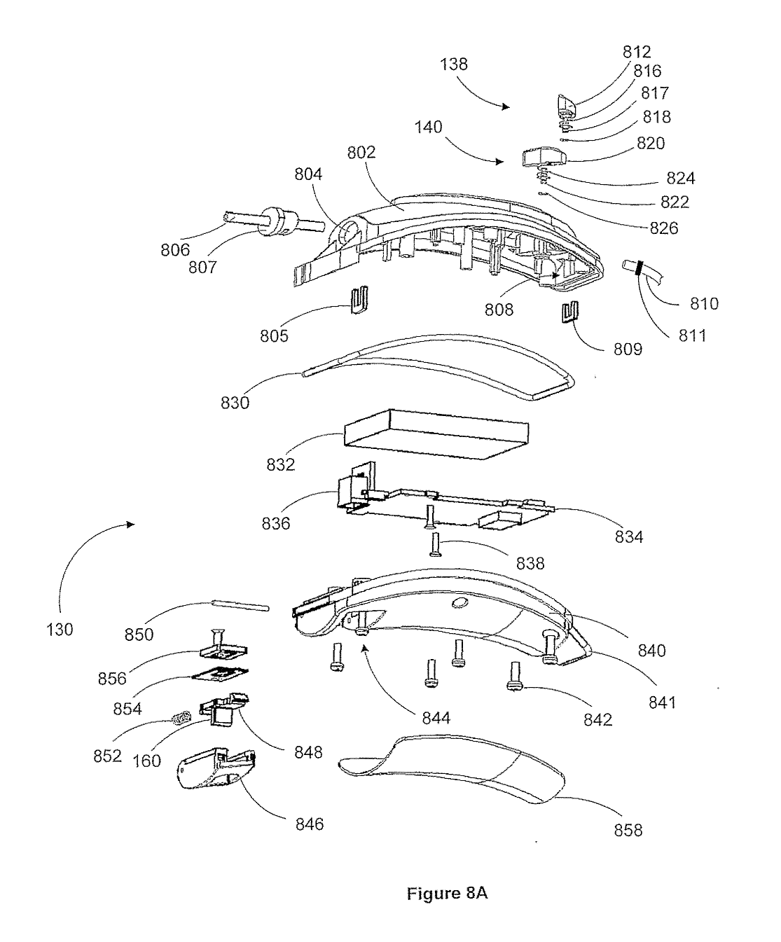

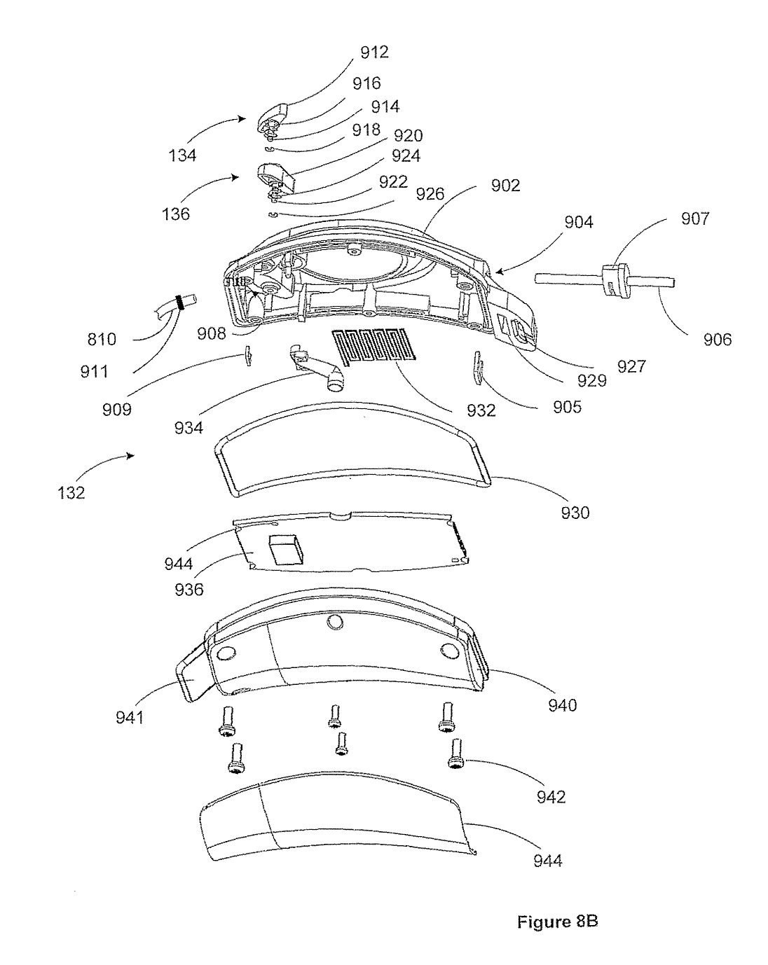

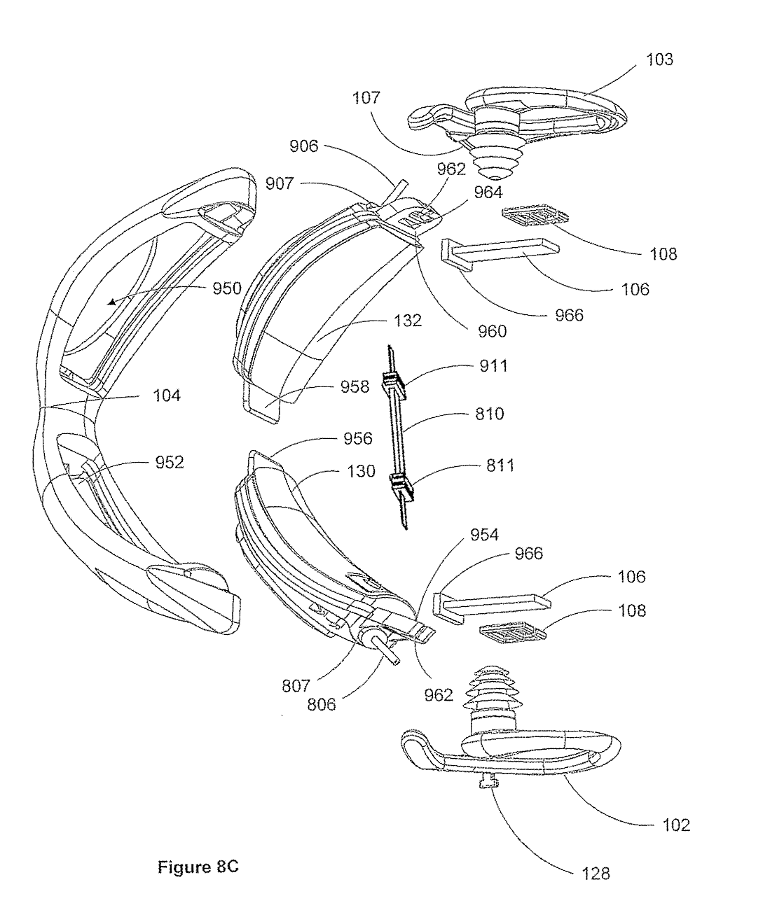

Referring to FIG. 7, a functional block diagram depicting the components of the headset 100 will now be described. The physical layout of these components is described below in relation to FIGS. 8A, 8B and 8C. As will be appreciated alternative or additional components may be included to achieve a particular functionality, and different arrangement of the components (physically and/or logically) is possible. The arrangement of FIG. 7 includes an MP3 function; an FM radio function, elements of a heart-rate monitor and a receiver circuit for receiving mobile radio transmissions. Alternative arrangements may include fewer functional blocks. For example, one arrangement may include the MP3 and FM functions but not the receiver and heart-rate monitor. Another arrangement may include the MP3 and mobile radio receiver functions but not the heart-rate monitor.

The headset includes a main processing unit 702 with a 32.768 kilohertz timing crystal 704. The main processing unit 702 is connected to:
user interface buttons 706 (which include user buttons 134, 136, 138 and 140 as described above);
an electronically erasable programmable memory (EEPROM) 708 on which the headset firmware is recorded; and
a light emitting diode 710 (shown physically as 152 in FIGS. 1 and 2).

In the depicted arrangement the processing unit 702 receives information from a heart rate monitor 712, which has an antenna for receiving signals from a heart rate transmitter. The transmitter may, for example, be a heart-rate belt worn by the user, and the headset may provide the user with heart-rate information through earphones 762, 764. The main processing unit is connected to earphones 762, 764 via a flat cable connector 752 and a slave audio processor 750. The power supplied to the heart rate monitor 712 is regulated by a 3.2 Volt regulator 714.

An FM module 717 is also connected to the main processing unit 702. The FM module may be a standard unit that receives broadcast radio signals such as transmissions from commercial radio stations. If the headset is in an FM radio mode, the output of the FM module is played through earphones 762, 764 (via the main processing unit 702 and the audio processor 750). The user interface buttons 706 enable the user to switch to the FM radio mode, change channels and change volume.

The main processor 702 may also be connected to a mobile radio receiver circuit which includes:
a phase locked loop circuit 718, connected in turn to a 20.95 Kilohertz timing crystal 720;
a voltage controlled oscillator (VCO) amplifier 722;
a voltage controlled oscillator VCO receiver 724;
a mixing circuit 726;
a filter 728;
an amplifier 730;
an antenna 732;
an intermediate frequency filter 734;
an FM demodulator 736;
a continuous tone-coded squelch system (CTCSS) decoder 716; and
an audio frequency amplifier 738.

The mobile radio receiver circuit uses CTCSS coding, which allows the receiver to be activated only when the correct tone is received. This enables selective transmission to a particular headset. For example, a coach may want to communicate with a single player or subset of players in a group. The coach may, using controls on his or her mobile radio transmitter, select a CTCSS tone corresponding to the player or subset of players. This selected tone is transmitted together with the mobile radio transmission (for example, the coach's instructions). Users of other headsets that are within range but which use a different CTCSS tone will not hear the mobile radio transmission.

The CTCSS tones have a relatively low frequency and can be filtered out before the audio signal is played through the earphones 762, 764.

The receiver circuit may, for example, be configured to receive 8 channels in the PMR (private/professional mobile radio) band of 446.0-446.1 MHz and/or 14 channels in the FRS band 462.0-467.0 MHz. Thirty-eight CTCSS codes may be provided. One code may be a default code and the remaining 37 may be selectable.

Antenna 732 receives the mobile radio signal having the CTCSS code. The received signal is amplified by RF amplifier 730 and passes through filter 728 to mixing circuit 726, which also receives the output of the VCO receiver 724. An output of phase-locked loop 718 is amplified by VCO amplifier 722 and provide to the VCO receiver 724.

The output of the mixing circuit 726 is filtered by the intermediate-frequency filter 734 and demodulated by FM demodulator 736. The CTCSS demodulator 716 receives the output of demodulator 736 and determines whether the appropriate CTCSS code is present in the received signal. If so, the main processing unit 702 is flagged and the received mobile radio signal is passed to the earphones 762, 764 through flat cable connector 752 and the audio processor 750. The output of the FM demodulator 736 is amplified by audio-frequency amplifier 738 before reaching the flat cable connector 752.

The audio processor 750 is connected to a 24 MegaHertz timing crystal 751 and is adapted to decode and play audio data of various formats (for example .mp3, .wav, .wma files). The audio processor is, in turn, connected to:
a rewritable flash memory module 754 for storing audio data;
a USB connector 756 that may, for example, be linked to a computer in order to load audio data onto the memory 754;
a power source 758 in the form of a Lithium ion battery and having an output regulated via a 3.2 Volt regulator 760;
audio output transducers in the form of a first earphone 762 and a second earphone 764.

Operation of the headset 100 is controlled primarily through the main processor 702. As discussed in greater detail below, the main processor 702 can be controlled to operate in a variety of different modes, such as:
a music playback mode, where the main processor 702 communicates with the audio processor 750 to play audio data to the user through the first and second earphones 762 and 764;
a heart rate monitor mode where the main processor 702 monitors for a heart rate signal (to be sent from an external heart rate belt or similar) and provides the user with audio feedback regarding their heartrate through the first and second earphones 762 and 764;
a radio receiver mode where the main processor 702 receives mobile radio signals encoded with the appropriate CTCSS code via the radio receiver circuit and plays the radio signal to the user through the first and second earphones 762 and 764.

### Equipment Modules—Physical Components

The physical components housed in the equipment modules 130 and 132 will now be described with reference to FIGS. 8A and 8B. FIG. 8C will then be discussed to with respect to the assembly of the equipment modules 130 and 132 into the housing 104 and attachment of the ear assemblies 102 and 103 to the housing 104.

### Left Equipment Module

FIG. 8A shows an exploded view of the left equipment module 130 which includes:
a left housing 802. The left housing 802 includes:
   a left cable opening 804 through which the cable 806 (leading to the left ear assembly 102) travels. When assembled cable 806 is secured in place by cable plate 805. Cable 806 includes a rubber seal 807 which seats in the left cable opening 804 to provide a water tight seal.
   a right cable opening 808 though which the cable 810 (connecting the left equipment module 130 to the right equipment module 132) travels. When assembled cable 810 is secured in place by cable plate 809. Cable 810 includes a rubber seal 811 which seats in the right cable opening 808 to provide a water tight seal.
   user button 138, which includes actuator 812, shaft 814, spring 816 and seal 818. The button components are secured in the left housing 802 such that the spring 816 biases the shaft 814 into an off position. When a user depresses the actuator 812 against the spring 816 the button 138 makes contact with and activates a push button switch mounted on the left PCB 834. The seal 818 is waterproof and prevents water entering the equipment module where the button 138 enters the left housing 802;
   user button 140, which includes actuator 820, shaft 822, spring 824, and seal 826. The button components are secured in the left housing 802 such that the spring 824 biases the shaft 822 into an off position. When a user depresses the actuator 820 against the spring the button 140 makes contact with and activates a push button switch mounted on the left PCB 834. The seal 826 is waterproof and prevents water entering the equipment module where the button 140 enters the left housing 802;
   a left lug 825, including a cable cutout (obscured) and a strap cutout (obscured);
   the left housing 802 also includes various mounting lugs and protrusions and threaded bores for mounting and securing the components of the left equipment module 130;
a rubber sealing ring 830 which provides a watertight seal between the left housing 802 and left cover 840 when the left equipment module 130 is assembled;
a battery 832 (i.e. the lithium ion battery 758 described above with reference to FIG. 7);
the left printed circuit board (PCB) 834. The left PCB 834 includes the MP3 processor 750, timing crystal 751, the flash memory 754, the regulator 760, a USB port 836 (and circuitry for the USB connector 756) as described above with reference to FIG. 7. The left PCB 834 is secured in the left housing 802 via screws 836 which are screwed into complementary threaded bores in the left housing 802;
the left cover 840 which is securable to the left housing 802 via screws 842. The left cover 840 includes a right lug 841 and a USB opening 844 which opens into the USB port 836 when assembled. Access to the USB opening 844 is achieved via a USB cover 846 in which hatch 848 is mounted. Hatch 848 is a hinged hatch mounted by hinge 850 and biased to a closed position by spring 852. The hatch 848 rests on a plate 854 and a waterproof seal is provided by a rubber USB seal 856. The hatch 848 is provided with a user manipulable ridge by which a user can slide the hatch 848 against the bias of the spring 852 to open the hatch 848 and allow access to the USB port, or slide the hatch 848 in the same direction of the bias of the spring 852 to lock the hatch 848 closed; and
a left foam layer 858 which is secured (e.g. by an adhesive) to the outside of the left cover 840. The left foam layer 858 provides a comfortable surface for resting against a user's head when the headset 100 is in use.

As will be appreciated, when assembled the battery 832 and left PCB 834 are secured within between the left housing 802 and left cover 840. Waterproofing of the left equipment module 130 is provided by:
the rubber seal 830 between the left housing 802 and left cover 840;
the rubber seal 807 on cable 806, sealing cable opening 804;
the rubber seal 811 on cable 810, sealing cable opening 808;
button seals 818 and 826; and
the USB rubber seal 856, sealing the USB opening 844 (when the hatch 848 is locked closed).

### Right Equipment Module

FIG. 8B shows an exploded view of the right equipment module 132 which includes:
a right housing 902. The right housing 902 includes:
   a right cable opening 904 through which cable 906 (leading to the right ear assembly 103) travels. When assembled cable 906 is secured in place by cable plate 905. Cable 906 is fitted with a rubber seal 907 which seats in the right cable opening 904 to provide a water tight seal.
   a left cable opening 908 though which the cable 810 (connecting the right equipment module 132 to the left equipment module 130) travels. When assembled cable 810 is secured in place by cable plate 909. Cable 810 also includes a rubber seal 911 which seats in the left cable opening 908 to provide a water tight seal.
   user button 134, which includes actuator 912, shaft 914, spring 916 and seal 918. The button components are secured in the right housing 902 such that the spring 916 biases the shaft 914 into an off position. When a user depresses the actuator 912 against the spring 916 the button 134 makes contact with and activates a push button switch mounted on the right PCB 936. The seal 918 is waterproof and prevents water entering the equipment module where the interface between the button 134 enters the right housing 902;
   user button 136, which includes actuator 920, shaft 922, spring 924, and seal 926. The button components are secured in the right housing 902 such that the spring 924 biases the shaft 922 into an off position. When a user depresses the actuator 920 against the spring the button 136 makes contact with and activates a push button switch mounted on the right PCB 936. The seal 926 is waterproof and prevents water entering the equipment module where the button 136 enters the right housing 902;
   a right lug 925, including a cable cutout 927 and a strap cutout 929;
   the right housing 902 also includes various mounting lugs and protrusions and threaded bores for mounting and securing the components of the left equipment module 130;
a rubber sealing ring 930 which provides a watertight seal between the right housing 902 and right cover when the right equipment module 132 is assembled;
the antenna 732 (i.e. the antenna 732 described above with reference to FIG. 7);
a light guide 934 which serves to guide light from the LED (710 in FIG. 7) mounted on the right PCB 936 to a transparent portion of the right housing 902 (not shown) where it may be seen by a user;
the right PCB 936. The right PCB 936 includes the main processing unit 702, timing crystal 704, EEPROM 708, receiver circuit, LED 710, heart rate monitor 712, regulator 714, FM module 717 and CTSS DE CODE 716 as described above with reference to FIG. 7;
the right cover 940 which is securable to the right housing 902 via screws 942. Screws 942 pass through openings in the right cover 940, aligned holes 944 in the right PCB 936 and into aligned threaded bores in the right housing 902. The right cover 940 includes a left lug 941; and
a right foam layer 944 which is secured (e.g. by an adhesive) to the outside of the right cover 940. The left foam layer 944 provides a comfortable surface for resting against a user's head when the headset 100 is in use.

As will be appreciated, when assembled the right PCB 936 is secured between the right housing 902 and right cover 940. Waterproofing of the right equipment module 132 is provided by:
the rubber seal 930 between the right housing 902 and right cover 940;
the rubber seal 907 on cable 906, sealing cable opening 904;
the rubber seal 911 on cable 810, sealing cable opening 908; and
button seals 918 and 926.

While FIGS. 8A and 8B provide one physical arrangement of the various components into equipment modules 130 and 132, alternative arrangements (including additional components) are of course possible.

### Headset Assembly

FIG. 8C provides a partially exploded view showing how the various components of the headset 100 are assembled.

The housing 104 is provided with two cavities 950 and 952 for receiving the left and right equipment modules 130 and 132 respectively. A noted above, the housing 104 is constructed from an elastic material. This allows the housing 104 to be elastically deformed in order to insert/remove the equipment modules 130/132 from the housing 104 and, once the equipment modules 130/132 have been placed in the cavities 950/952 the elasticity of the housing 104 secures them therein.

To assist in the securement of the left equipment module 130 into the cavities 950, the left lug 825 and right lug 841 are received in complementary openings in the housing 104. Similarly, securement of the right equipment module 132 is aided by the right lug 925 and the left lug 941 which are received in the housing 104.

Referring to the right equipment module 132, the cable cutout 927 and strap cutout 929 are used for management of cable 906 and attachment of the right ear assembly 103. Cable 906 passes through the cable cutout 927 and towards the right ear assembly 103. Strap 106 fed through the strap cutout 929. Strap 106 is provided with a flattened end 966 which prevents the strap 106 being pulled the entire way through the strap cutout 929 serving to secure the strap 106 to the equipment module.

The strap 106 then passes through the buckle 108, around the attachment point 107 of the right ear assembly 103 and back through the buckle 108. As will be appreciated the strap 106 may be adjusted through the buckle 108 to shorten or lengthen the distance between the ear assembly 103 and the housing 104.

The attachment of the left ear assembly 102 is achieved in the same manner as that described for the right ear assembly 103.

### Headset Functionality

By using the user buttons 134, 136, 138, and 140 a user of the headset 100 may operate the headset 100 in different modes. During operation and use the main processing unit 702 is programmed to provide a user of the headset 100 with voice guidance statements which advise the user of various functions and settings.

### Music Mode

The headset 100 may be placed in a music mode which allows the user to listen to audio data stored on the flash memory 754 of the headset 100. As noted above, the audio processor 750 is configured to decode audio data and play the decoded data to the user via transducers 115.

The audio data may be stored on the flash memory 754, for example, in a data format such as mP3, way, wma or any other known data format appropriate for encoding and storing audio data. In alternative embodiments the audio data may be streamed via a wireless connection to the headset 100.

The type of audio data may also be of any appropriate kind depending on the intended use of the headset 100, such as music and/or educational materials.

Once in the audio playback mode the user buttons 134, 136, 138, and 140 may be used (as discussed in more detail below) to commence and cease play of audio files, to skip backwards and forwards between different audio files, or scan backwards and forwards within audio files.

### Music Setting Mode

In the music setting mode a user may toggle various options to be active or inactive. These options include:
a bass boost to enhance the bass;
a shuffle mode to play back the audio files in a random order;
a heart rate monitor on/off mode allowing the user to activate or deactivate the heart rate monitor.

Other options may also be included as desired, such as a “repeat all” mode to loop all tracks in continuous play or a “repeat one” mode to loop a single track in continuous play.

### Commercial Radio

As an alternative to listening to audio data stored on the memory of the headset 100, the headset 100 may also be placed in a commercial radio mode that allows the user to listen into AM or FM radio stations by tuning into a desired frequency. The headset 100 also allows for certain AM and FM frequencies to be stored as pre-set channels.

RF Receiver Mode

As a further alternative, the headset 100 may be used in an RF receiver mode in which the headset 100 is tuned to pick up radio signals from a dedicated transmitter and play those signals to the user as audio data through transducers 115.

This mode may be used, for example, to allow a sporting coach or teacher to transmit an audio signal to one or more specific users.

In the present embodiment the headset 100 may be set at to receive mobile radio signals over channels in the PMR frequency band 446.0-446.1 MHz or the FRS frequency band 462.0-467.0 MHz. These channels have 38 associated CTCSS codes. Using these codes the user of the headset 100 receives (and is able to hear) audio transmitted to the headset. The headset 100 may recognise at least two CTCSS codes, a default code common to a group of headsets and at least one other code.

By providing the headset 100 with two CTCSS codes, a person wishing to communicate with the headset 100 can do so selectively. This is particularly useful where a group of people, such as a sporting team or class, are each wearing headsets 100. Taking, as an example, a football team at a training session, the default CTCSS code may apply to all headsets for the team, but the other CTCSS code for individual headsets may beset differently according to their field position.

For example, the headsets 100 of offensive players may have a default code of 1 and a further CTCSS code of 2 while the defensive players may have a default code of 1 and a further code of 3. With this arrangement the coach can elect to address comments to the entire team (by transmitting with the default CTCSS code), to only address the offensive members of the team (by transmitting with CTCSS code 2), or to address only the defensive members of the team (by transmitting with the CTCSS code 3).

RF Receiver Setting Mode

In the RF receiver setting mode the user can toggle various options to be active or inactive. These options include:
changing the channel into which the RF receiver is tuned;
activating or deactivating the receiver voice over
activating or deactivating the heart rate monitor.

Depending on the intended use of the headset 100, the headset 100 may be configured such that anyone can change the channels received in the RF receiver mode and/or whether the voice over is on or off, or may be configured such that only an authorised person can change these options.

The headset 100 may also be configured such that if a signal is received on either the master or sub channel the headset 100 automatically plays the signal to the user (i.e. the headset 100 does not specifically need to be set into the RF receiver mode in order to receive signals). This may be useful, for example, if a coach or teacher only intends to make intermittent comments to their team/students. This allows the headset users to listen to either the radio or playback stored audio data (as discussed above) without fear that a message sent to them via their master or sub channel will be missed.

While the headset 100 has been described with two channels more or less channels may be provided as desired.

### Heart Rate Monitor Mode

The headset 100 is also provided with a heart rate monitor for receiving and processing a signal carrying data about the heart rate of a user. In this embodiment the data signal is sent to the heart rate monitor from a strap worn around the chest of a user, however other devices for sending heart rate signals to the heart rate monitor may alternatively be used.

When in the heart rate monitoring mode is operational, the headset controller is configured to provide audio feedback to a user (via transducers 115) regarding their heart rate. For example, the headset controller may be set to an interval of 60 seconds in which case each 60 seconds the user is informed by a vocal message what their heart rate is at that particular time. The interval may, of course, be changed by the user to whatever frequency desired.

If desired, the main processor 750 may be configured to allow a user to set heart rate alarms such that the headset controller provides the user with a vocal notification if their heart rate exceeds a certain limit or drops below a certain limit, or if the rate of change of their heart rate exceeds a certain limit or drops below a certain limit. These limits may be set by use of the user buttons and stored in the headset memory.

The main processor 750 may also be configured to calculate the approximate calories expended by a user on the basis of the user's heart rate over time. In this case the headset controller may also or alternatively keep the user informed (again by a vocal alert through the transducers 115) of their calorie burn at a prescribed interval, or may advise the user when a certain number of calories have been used (the interval and/or certain number of calories set by the user via the user buttons).

When in the heart rate monitor mode the headset controller logs and stores a record of the user's heart rate data on the flash memory 754.

The headset controller may be programmed to automatically launch the heart rate monitoring mode when a heart rate signal is detected (and disable the heart rate monitoring mode if no heart rate signal is detected within a set period of time), or may require a user to specifically launch and exit the heart rate mode via operation of the user buttons.

As will be appreciated, the heart rate monitoring mode can operate at the same time as other modes, for example the MP3 mode. In this case the vocal alerts provided by the headset controller (e.g. the periodic heart rate report or the alarms) may be played over the top of any audio data (such as music) being played, or the headset controller may pause the audio data, deliver the vocal alert, and then resume play of the audio data.

### Headset Interfaces

The headset 100 is provided with a number of interfaces that allow a user to interact with the headset 100.

### User Buttons

As described above, the headset 100 includes four user buttons 134, 136, 138 and 140 that allow a user to control the operation of the headset 100. Each button may be operated in two different ways—a long press of the button (i.e. by holding the button down for two or more seconds) or a short press of the button (i.e. depressing the button down for less than two seconds).

The headset controller is configured to execute different operations depending on how a button is operated (short or long press) and the mode of operation the headset 100 is in. The specific functions of each button at each mode of operation are described below.

### USB Data Transfer Interface

As discussed above, the headset 100 is also provided with a USB input port 156. The USB port 156 allows the headset 100 to be connected to a computer device via a USB cable. This in turn allows data to be transferred from the computer device to the memory of the headset 100 (for example the upload of audio files), or from the memory of the headset 100 to the computer (for example the download of heart rate data).

### Light Emitting Diode

The LED 152 provides visual information to a user of the headset 100. The headset controller controls the LED 152 to either be off, on, or flashing in a particular sequence. As such, the LED 152 can tell a user (for example) that the headset 100 is turned on and operations, that the headset is turned off, that the battery charge of the headset 100 is low, or that an error or malfunction has occurred in the headset 100.

### Headset Operation

During operation of the headset 100 a user selects the mode of operation and controls that operation via user buttons 134, 136, 138 and 140.

Depending on the type of operation of the button (e.g. short or long press) and the mode of operation, the particular function of each button varies. In addition, the headset controller is configured to provide vocal feedback to the user regarding the particular mode and options selected.

The below tables provides a summary of the various functions of the user buttons in the various modes of operation of the headset 100:

Off mode

| | Short press | | Long press | |
|---|---|---|---|---|
| | (<2 seconds) | | (>2 seconds) | |
| | | Voice | | Voice |
| | Function | guidance | Function | guidance |
| Button 136 | None | None | None | None |
| (Mode) | | | | |
| Button 134 | None | None | Turn power | “Power On: |
| (Play/stop/power) | | | on | Audio mode” |
| Button 140 | None | None | None | None |
| (Up) | | | | |
| Button 138 | None | None | None | None |
| (Down) | | | | |

Music mode

| | Short press (<2 seconds) | | Long press (>2 seconds) | |
|---|---|---|---|---|
| | Function | Voice guidance | Function | Voice guidance |
| Button 136 | Change to | “Receiver | Change to | “Music setting |
| (Mode) | receiver mode | mode” | music setting | mode” |
| | | | mode | |
| Button 134 | Toggle play and | 1 KHz tone for | Power Off | “Power off” |
| (Play/stop/power) | stop | 10 ms | | |
| Button 140 | Volume up | 1 KHz tone for | Next song | 1 KHz tone for |
| (Up) | | 10 ms | | 10 ms |
| Button 138 | Volume down | 1 KHz tone for | Previous song | 1 KHz tone for |
| (Down) | | 10 ms | | 10 ms |

Receiver mode

| | Short press (<2 seconds) | | Long press (>2 seconds) | |
|---|---|---|---|---|
| | Function | Voice guidance | Function | Voice guidance |
| Button 136 | Change to Radio | “radio mode” | Change to | “Receiver |
| (Mode) | mode | | receiver setting | setting mode” |
| | | | mode | |
| Button 134 | Channel up | “Channel X” | Power Off | “Power off” |
| (Play/stop/power) | | | | |
| Button 140 | Volume up | 1 KHz tone for | Channel up | “Channel X” |
| (Up) | | 10 ms | | |
| Button 138 | Volume down | 1 KHz tone for | Channel down | “Channel X” |
| (Down) | | 10 ms | | |

Radio mode

| | Short press (<2 seconds) | | Long press (>2 seconds) | |
|---|---|---|---|---|
| | Function | Voice guidance | Function | Voice guidance |
| Button 136 | Change to Music | “Music mode” | None | None |
| (Mode) | mode | | | |
| Button 134 | Channel up | “Channel X” | Power Off | “Power off” |
| (Play/stop/power) | | | | |
| Button 140 | Volume up | 1 KHz tone for | Channel up | “Channel X” |
| (Up) | | 10 ms | | |
| Button 138 | Volume down | 1 KHz tone for | Channel down | “Channel X” |
| (Down) | | 10 ms | | |

Music setting mode

| | Short press (<2 seconds) | | Long press (>2 seconds) | |
|---|---|---|---|---|
| | Function | Voice guidance | Function | Voice guidance |
| Button 136 | Cycle through: | 1. “Bass boost | Cycle through: | 1. “Bass boost |
| (Mode) | 1. Bass boost | on/off” | 1. Bass boost | on/off” |
| | 2. Shuffle | 2. “Shuffle | 2. Shuffle | 2. “Shuffle |
| | 3. HRM | on/off” | 3. HRM | on/off” |
| | 4. Return to | 3. “Heart rate | 4. Music mode | 3. “Heart rate |
| | music mode | monitor on/off” | | monitor on/off” |
| | | 4. “Music mode” | | 4. “Music mode” |
| Button 134 | None | None | Power Off | “Power off” |
| (Play/stop/power) | | | | |
| Button 140 | Activate setting | 1. “Bass boost | None | None |
| (Up) | | on” | | |
| | | 2. “Shuffle on” | | |
| | | 3. “Heart rate | | |
| | | monitor on” | | |
| Button 138 | Deactivate | 1. “Bass boost | None | None |
| (Down) | setting | off” | | |
| | | 2. “Shuffle off” | | |
| | | 3. “Heart rate | | |
| | | monitor off” | | |

Receiver setting mode

| | Short press (<2 seconds) | | Long press (>2 seconds) | |
|---|---|---|---|---|
| | Function | Voice guidance | Function | Voice guidance |
| Button 136 | Cycle through: | 1. “Sub channel | Cycle through: | 1. “Sub channel |
| (Mode) | 1. Sub channel | x” | 1. Sub channel | x” |
| | 2. Receiver | 2. “Receiver | 2. Receiver | 2. “Receiver |
| | voice over | voice over | voice over | voice over |
| | 2. HRM | on/off” | 2. HRM | on/off” |
| | 3. Return to | 3. “Heart rate | 3. Return to | 3. “Heart rate |
| | receiver mode | monitor on/off” | receiver mode | monitor on/off” |
| | | 4. “Receiver | | 4. “Receiver |
| | | mode” | | mode” |
| Button 134 | None | None | Power Off | “Power off” |
| (Play/stop/power) | | | | |
| Button 140 | Activate setting | 1. “Sub channel | None | None |
| (Up) | | x” | | |
| | | 2. “Receiver | | |
| | | voice over on” | | |
| | | 3. “Heart rate | | |
| | | monitor on” | | |
| | | 4. “Receiver | | |
| | | mode” | | |
| Button 138 | Deactivate | 1. “Sub channel | None | None |
| (Down) | setting | x” | | |
| | | 2. “Receiver | | |
| | | voice over off” | | |
| | | 3. “Heart rate | | |
| | | monitor off” | | |
| | | 4. “Receiver | | |
| | | mode” | | |

As previously noted, it is to be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A headset including first and second ear assemblies, each ear assembly including a rear limb, a front limb, a transducer carried on the front limb, and an earpiece extending from the front limb, the rear limb configured to locate behind a user's ear, the front limb configured to extend around an upper portion of the user's ear and locate the earpiece in or near an ear canal of the user, the headset further including a flexible elongate housing configured to house one or more equipment modules, the housing configured to fit conformingly around a nape region of the user's neck when the headset is worn, and wherein each ear assembly is connected to the housing and/or the equipment modules by an elastic strap.

2. A headset according to claim 1, wherein the rear limb extends downwardly and terminates in an inwardly angled portion which, in use, is arranged to abut against the user's head.

3. A headset according to claim 1, wherein the transducer is located in a transducer housing, the transducer housing extending normally from the upper arm.

4. A headset according to claim 1, further including first and second relatively rigid equipment modules housed towards opposite ends of the elongate housing and spaced apart from one another by a central flexible region, the central region corresponding to the centre of the nape region of the user's neck when the headset is worn.

5. A headset according to claim 4, wherein the housing includes first and second elastically deformable cavities for receiving respectively the first and second equipment modules.

6. A headset according to claim 5, wherein the first and second equipment modules are interconnected by a flexible cable, the flexible cable passing through the central region.

7. A headset according to claim 5, wherein the first equipment module is electrically connected to the transducer of the first ear assembly by a first flexible cable, and the second equipment module is electrically connected to the transducer of the second ear assembly by a second flexible cable.

8. A headset according to claim 5, wherein the first and/or second equipment modules include user operable buttons, the user operable buttons operable through the material of the housing.

9. A headset according to claim 5, wherein the first and/or second equipment modules include user operable buttons, the user operable buttons operable through openings in the material of the housing.

10. A headset according to claim 1 further including first and second attachment points for attaching a front head band which, in use, extends around a forehead of the user to aid in securement of the headset to the user's head.

11. A headset according to claim 10, wherein the first and second attachment points are respectively located on the first and second ear assemblies.

12. A headset according to claim 5, wherein the first and second equipment modules collectively house a processor, a memory, a radio receiver, and a battery.

13. A headset according to claim 12, wherein the processor is adapted to decode digital audio data stored on the memory and play said digital audio data to the user through the first and/or second transducers.

14. A headset according to claim 12, wherein the radio receiver is adapted to receive a radio signal for playing though the first and/or second transducers.

15. A headset according to claim 12, wherein the radio receiver is adapted to oscillate between at least two radio frequencies to receive radio signals broadcast on said at least two frequencies for playing through the first and/or second transducers.

16. A headset according to claim 12, wherein the processor is adapted to receive heart rate signals carrying information relating to the heart rate of the user and to provide audio feedback regarding the user's heart rate to the user through the first and/or second transducers.

17. A headset including first and second ear assemblies being shaped to locate first and second transducers in or near the ear canal of a user, the first and second ear assemblies connected to a resilient support carrying at least one equipment module, the first and second ear assemblies being in electrical communication with the at least one equipment module, the at least one equipment module housing a processor, a receiver, a memory, and a battery, the processor adapted to process audio data stored on the memory and play said audio data to a user through the first and/or second transducers.

18. A headset according to claim 17, wherein the receiver is a radio receiver adapted to receive a radio signal for playing though the first and/or second transducers.

19. A headset according to claim 18, wherein the radio receiver is adapted to oscillate between at least two radio frequencies to receive radio signals broadcast on said at least two frequencies for playing through the first and/or second transducers.

20. A headset according to claim 17, wherein the processor is adapted to receive heart rate signals carrying information relating to the heart rate of the user and to provide audio feedback regarding the user's heart rate to the user through the first and/or second transducers.

21. A headset according to claim 1, wherein the headset is waterproof.
